(19) United States
(12) Patent Application Publication
(10) Pub. No.: US 2022/0099983 A1
(43) Pub. Date: Mar. 31, 2022

(54) BASIC CONTROL OF A HEAD-MOUNTED-DISPLAY BY CONTROLLING THE POSITION OF A TEMPLE OF A SPECTACLE FRAME

(71) Applicant: tooz technologies GmbH, Aalen (DE)

(72) Inventor: Marko Yliniemelä, Oulu (FI)

(21) Appl. No.: 17/490,625

(22) Filed: Sep. 30, 2021

(30) Foreign Application Priority Data
Sep. 30, 2020 (DE) 10 2020 212 392.6

(51) Int. Cl. G02B 27/01; G06F 3/01

(52) U.S. Cl. CPC G02B 27/0176; G02B 2027/0178; G06F 3/011

(57) ABSTRACT

A method for controlling a basic function of a head-mounted display (HMD) includes at least one sensor unit which detects whether at least one temple of the spectacle frame of the HMD is in an extended position and wherein the control of the basic function of the HMD depends on the detection. An HMD controllable according to the method is also disclosed.

### CROSS REFERENCE TO RELATED APPLICATION

This application claims priority of German patent application no. 10 2020 212 392.6, filed Sep. 30, 2020, the entire content of which is incorporated herein by reference.

### TECHNICAL FIELD

The disclosure is directed to a method for controlling a basic function of an HMD, wherein at least one sensor detects whether at least one temple of the spectacle frame of the HMD is in an extended position and wherein the control of the basic function of the HMD depends on the detection.

The disclosure is furthermore directed to an HMD controllable according to the method.

### BACKGROUND

Head-mounted displays (HMDs) and in particular data glasses typically use dedicated buttons or a touch pad area for a user input method. One of the typical inputs is to power on and off the glasses. Separate buttons or touch pad areas require additional hardware and are also challenging to implement in a frame. It is in particular desirable to implement basic inputs, such as power on/off and/or power management by a simple method which is easy to implement method.

### SUMMARY

An object of the invention is to provide a method for controlling a basic function of an HMD as well as to provide an HMD which is controllable by the method which do not have the disadvantages of the state of the art.

It is also an object of the invention to provide a method for controlling basic functions of an HMD which is simple and inexpensive to implement, practical, robust mechanically as well as electronically, very intuitive for the user and which can be realized also under difficult circumstances. It is a further object of the invention to provide an HMD controllable by the method which is very simple and inexpensive in production, very robust and which allows a simple and intuitive control of a basic function.

In an aspect, the disclosure relates to a method for a control of a basic function of a head mounted display. The device includes a spectacle frame comprising a chassis and two foldable temples. The method includes the steps of a detection, by at least one sensor, whether at least one temple is in an extended position and a control of the basic function of the head-mounted display depending on the detection.

In another aspect, the disclosure relates to a method to control the power mode of data glasses. If, for example, the left temple of the spectacle frame is extended, the data glasses are in a power on mode. Then, in this example, if the left temple is folded or retracted, respectively, the data glasses are in power off mode. Depending on the embodiment, this method of controlling the power mode can be implemented regardless of the state of the other temple, for example, here the right temple. The detection whether the left temple is extended or not can, for example, be realized by a simple electro-mechanical switch, which functions as an on-switch when the temple is extended and as an off-switch when the temple is folded. The switch can, for example, transition between on and off at a well-defined position of the temple, which is situated between these extreme positions, for example, halfway between both positions or shortly before a (fully) extended position is reached.

Preferably, the spectacle frame is configured for an at least temporary fixation of the system to a head of a user and includes a functional unit including a visual data output connected/attached to the spectacle frame. It is known by the skilled person that spectacle frames are typically used for a temporary fixation of an HMD to the head of a user, in particular along the temples/behind the ears. For this purpose, preferably two temples, a first one and a second one (one for each side of the head and/or for each ear) are included within the spectacle frame.

The spectacle frame includes a chassis. The chassis is preferably the part of the spectacle frame to which a functional unit and in particular a visual data output of the head-mounted-display (HMD) is attached. For example, in the case of data glasses, the spectacle frame and in particular the chassis can have the general outline as known from “classical” glasses which serve as vision aids.

Temples preferably provide a connection between the chassis and the head/the temples of the wearer. They are typically configured to ensure a firm fit of the HMD.

For practical purposes, temples are foldable such that the HMD can be brought into a compact position, for example, for the purpose of transportation of the HMD when it is not worn (for example, in a box/case). For this, temples can be attached to the chassis with small hinges.

The temples can be of different types, as is known by the person skilled in the art. The type can, for example, be chosen according to the circumstances during which the HMD is worn. They can be selected from the group comprising skull temples, library temples, convertible temples, riding bow temples and comfort cable temples.

To a skilled person it is clear that a spectacle frame of an HMD does not have to be of exactly the same form than for classical glasses used for vision correction. Rather, its exact configuration can depend on the type of HMD which has been realized (see below for different types). However, despite the variations possible, a spectacle frame preferably includes a chassis attached to the visual data output/functional unit of the HMD and foldable temples foldable connected to the chassis, which are used for fixing the HMD to the head of the user temporarily.

A head-mounted display is preferably a technical device which can be carried on the head of a user and in particular close to the eyes of a user. It can preferably feature a technical device with a dedicated functionality for the user, as for example the display, collection and/or processing of data.

The head-mounted-display (HMD) comprises in particular so-called data-glasses.

Preferably, the HMD includes a visual data output, as for example a display and/or a projector for projecting data on (transparent) glasses of the HMD, which are positioned in front of the eyes of a user of the HMD when it is worn. Visual data output, as used in this document, can be synonymous with functional unit and/or functional unit including a visual data output.

It can be preferred that the HMD includes a functional unit. A functional unit, as used with this disclosure, can be synonymous with a functional unit including a visual data output or just a visual data output.

A functional unit preferably describes a unit which includes functions related to a data input, a data output and/or data processing. It can include a data interface for data input and/or output. It can comprise functions of a smartphone. It can comprise a processing unit and/or a computer. The functional unit comprises in particular a visual data output, as for example a display and/or a projector. The functional unit can comprise an interface for communicating with an external electronical device, such as a smartphone and/or a computer. Like this, the functional device can be complementary to the electronical device, it can in particular complement the data input and/or data output abilities of the electronic device and/or it can enable a control of the device at least partially. A functional unit is preferably an electronic or optoelectronic functional unit. In particular, optical and/or electronical components are comprised in order for the unit to function as referred to above.

The functional unit comprising a visual data output is in particular transparent to the user, so that he/she can see beyond and/or through the visual data output, while at the same time data can be displayed. This can be achieved, for example, by a projector projecting the data onto transparent glasses and/or transparent glasses featuring optical structures that enable light to be guided and/or displayed without affecting the overall transparency to the user.

The control of the basic function is implemented by a detection by at least one sensor whether at least one temple (for example, the first temple) is in an extended position. This can mean in particular that the basic function is initiated by detecting that the at least one (for example, the first) temple is in an extended position. Having at least one temple in an extended position is a prerequisite for the HMD to be worn by the user. Typically, the HMD will only be in use when worn by the user. Thus, starting the basic function when at least one temple is in an extended position can implement a very intuitive and resource-friendly control of the HMD.

One temple can specifically be a first temple. A first temple can preferably be a specific one of the two temples, for example, a left temple or a right temple. Left and right as used within this disclosure are preferably defined as left and right as seen by a user wearing the HMD.

A second temple is preferably a specific temple which is not the first temple. In the case the first temple is a left temple, the second temple is preferably a right temple. In the case the first temple is a right temple, the second temple is preferably a left temple.

A detection whether at least one temple is in an extended position preferably means a detection whether no less than one temple is in an extended position. It can thus preferably mean a detection whether one temple is in an extended position (for example, a first temple or a second temple). This can preferably mean any one temple, but it can preferably also mean a particular temple (for example, at least the first temple). A detection whether no less than one temple is in an extended position can preferably also mean whether both (for example, the first and the second temple) are in an extended position.

At least a first temple preferably means no less than a first temple. It can thus mean only a first temple or both first and second temple.

It can be preferred that the basic function is initiated by detecting that the at least one temple is in an extended position.

It can also be preferred that the basic function is initiated by detecting that the at least one temple is not in an extended position.

The extended position can preferably comprise a fully extended position, for example, when the temple can essentially not be extended any further.

The extended position can also comprise a partially extended position, which is more extended then the (completely) folded position but is not yet a fully extended position.

It is preferred that the detection whether at least one temple (for example, the first temple) is in an extended position also implicitly comprises the detection whether at least one temple (for example, the first temple) is not in an extended position, in particular if it is in a folded position. In particular, a detection whether at least one temple (for example, the first temple) is in an extended position which yields a negative result yields that the at least one temple (for example, the first temple) is not in an extended position.

It is particularly preferred that the result of the detection is binary. In particular, the detection either yields that at least one temple (for example, the first temple) is in an extended position or that it is not in an extended position. Preferably, the basic function is controlled depending on the binary result and in a manner predictable or known to a user. As an example, a basic function can be a power mode (for example, either power on or power off) of the HMD, where upon detection that at least one temple (for example, the first temple) is in an extended position, the power on mode is initiated (or continued) and where upon detection that at least one temple (for example, the first temple) is not in an extended position, the power off mode is initiated (or continued).

A detection can preferably comprise a regular measurement whether at least one temple (for example, the first temple) is in an extended position (or not).

It can also be preferred that a detection only comprises measurements which are indicative to a change in the position of at least one temple (for example, the first temple), for example, a change from not being in an extended position to being in an extended position or vice versa.

The detection can in particular comprise the extended state of only the first temple, wherein the first temple is preferably a specific temple. This preferably means that the position (extended or retracted) of only the first temple is detected and/or considered for the basic control of the HMD. The first temple may, for example, be the left temple of the HMD as seen by the user when he/she wears the HMD. This would, for example, mean that only when the left temple is detected to be in an extended state the wearable device is controlled to be in a power on mode (alternatively power off mode).

It can also be preferred that the first temple is the right temple. Then, only the extended state or position of the right temple is considered to control the basic function.

This method is simple, efficient and inexpensive to implement, since advantageously only one measurement (preferably by only one sensor) for only a single temple has to be realized. It is advantageously sufficient to detect the extension of only a first temple because in any case both temples have to be extended in order for the HMD to be worn by the user, so the first one will be extended when the HMD is worn.

It can furthermore be preferred that the basic control depends on the extended position of both the first and the second temple. This would, for example, mean that the basic control of the HMD depends on the detection of an extension of both temples, which are simultaneously in an extended position. For example, both temples would have to be in an extended position in order to power on (or alternatively power off) the HMD. This embodiment is easy to use and particularly robust with regard to an accidental extension of one temple or an extension which was not performed with the intention to wear the HMD.

Alternatively, the position (extended or not) of both temples is detected, however, the detection that one of them is extended is sufficient in order to control the device. In this embodiment, a first temple preferably designates not a specific temple but an arbitrary temple of both temples. This embodiment can be understood as detecting whether at least one temple is in an extended position. In this embodiment, for the basic control it is irrelevant if one (the left or the right) temple is detected to be extended or both temples are detected to be extended (similar to an “OR” gate in digital logic—however not an “exclusive OR” or “XOR” gate). As an exemplary basic function which is realized when an extended position of at least one temple is detected, the wearable device can be put in a power-on state. This embodiment is very intuitive to use and particularly robust against a failing detection mechanism for one temple, for example, a faulty sensor.

By the described method, a very simple scheme to control basic functions of an HMD can be established. It is very intuitive to use and works very reliably. The detection of the position of at least the first temple can be implemented easily and offers an improved method to control basic functions of a wearable device. An advantageous and foolproof method is provided if the HMD is powered when at least the first temple is in an extended position. The at least first temple being in an extended position is a prerequisite for the HMD to be worn. Like this, resources, for example, electrical energy, can be saved since the power is switched on only when the device is worn or supposed to be worn.

In a preferred embodiment of the invention, the detection comprises detecting whether at least one of the first temple and the second temple is in an extended position. This preferably means that the detection of either one of both temples being in an extended position is sufficient to control the basic function, when both are extended nothing changes with respect to the case where only one temple is extended. This embodiment and its advantages have been described previously.

In a further preferred embodiment, the detection comprises detecting whether at least the first temple is in an extended position. There are preferably two possibilities for this embodiment: in one possible realization of this embodiment comprises detecting only whether the first temple is in an extended position. This could, for example, mean, detecting only whether the left temple is in an extended position. In the other possible realization, this embodiment comprises detecting whether both the first temple and the second temple are in an extended position.

In a further preferred embodiment of the invention, the detection comprises detecting only whether the first temple is in an extended position. This embodiment and its advantages have been described above.

In a further preferred embodiment of the invention, the detection comprises detecting whether both the first temple and the second temple are in an extended position, preferably simultaneously. This embodiment and its advantages have been described above.

In a preferred embodiment of the invention the head-mounted display is selected from the group comprising: data glasses, video glasses, first person view glasses, virtual reality headset, augmented reality glasses and/or smart glasses.

The method is particularly well suited for these types of HMD and represents an improved method for the control of a basic function of these types of HMD.

In a further preferred embodiment of the invention the basic function comprises a control of a power supply of the HMD. The control of the power supply preferably comprises the control whether the device is in a power on mode (or state) or in a power off mode (or state). Power off state (mode) is preferably defined as at least one battery or any other source of electrical energy which is disconnected from the (rest of the) HMD and/or the system/device is down. Power on state (mode) is preferably defined as the at least one battery or another source of electrical energy being connected to the (rest of the) HMD and/or the system/device/HMD is running normally. It is particularly useful and resource-friendly if the basic function comprises a control of the power supply of the HMD.

In a further preferred embodiment of the invention the detection that at least one temple is in an extended position causes a power-on mode of the HMD. This is particularly intuitive, efficient and practical.

In a further preferred embodiment of the invention the sensor comprises a switch, an electromagnetic sensor, preferably a Hall sensor and/or a capacitive sensor, an optical sensor and/or an accelerometer.

Preferably, at least one sensor is needed in order to detect a position of a single temple.

A sensor configured to measure whether at least one temple is in an extended position preferably describes at least one sensor configured to measure whether one temple is in an extended position or at least two sensors configured to measure whether at least one of a first temple and a second temple are in an extended position or configured to measure if both temples are in an extended position (simultaneously).

A (electromechanical) switch is preferably an electrical component which enables to disconnect or connect a conducting path in an electrical circuit. Advantageously, an electric current can be interrupted and/or diverted from one conductor to another one. For example, a switch can comprise electrical contacts which are movable at least in parts and where two corresponding pairs of contacts are preferably connected to more than one part of one or more electric circuits. It is then preferred that a current can pass between the parts when a pair of contacts is touching, while when the contacts are separated no current can flow. In particular, the switch can be connected between one side of a power supply and an electrical circuit of the system to be switched, which itself is connected to the other side of the power supply. Then, a switching can preferably cause a flow/an interruption of flow of an electrical current in the electrical circuit of the system.

Such a sensor could, for example, be arranged in such a way that one contact of a pair of contacts is attached to the chassis of the glasses in a region where the temple, whose position is to be detected, is joined to the chassis, whereas the other contact of a pair of contacts is attached to the temple in a region where the chassis is joined to the temple. They are preferably configured for being in contact only when the temple is in an extended position and for not being in contact when the temple is not in an extended position, in particular in a folded position. The contact attached to the temple can, for example be electrically connected to the power supply of the HMD, while the other contact of the contact pair is connected electrically to the functional unit of the HMD. Then, for example, only when the temple, whose position is to be detected is in an extended position, there is an electrical connection between power supply and functional unit and/or a control unit (electronics) of the HMD, allowing an electrical current to pass and supply the functional unit and/or control unit with electrical power.

It is clear to a skilled person that a description with respect to one of both temples, for example, a first temple would mutatis mutandis apply with respect to a detection whether a second temple is in an extended position.

A switch is a very simple and cost-sensitive solution. A particular advantage of the switch over many other sensors is its “double-functionality” as sensor and electrical switch at the same time. Whereas other sensors would, for example, activate a switch upon detection, this is advantageously not necessary for the switch. Therefore, for example, no permanent supply of electrical energy is needed in order to be functional as a sensor and no regular measurement has to be performed.

An electromagnetic sensor can be a resistive sensor, in particular a strain gauge or a potentiometer, configured to measure whether at least one temple is in an extended position. A skilled person knows how to employ the capabilities of a resistive sensor in order to measure an extended position of at least one temple. A resistive sensor is very robust.

An electromagnetic sensor can be a capacitive sensor configured to measure whether at least one temple is in an extended position. A skilled person knows how to employ the capabilities of a capacitive sensor in order to measure an extended position of at least one temple. For example, one electrode can be attached to the chassis of the glasses in a region where the temple, whose position is to be detected, is joined to the chassis, whereas a second electrode is attached to the temple in a region where the chassis is joined to the temple. Then, a folded position of the temple exhibits a different capacitance measured by the electrodes then an extended position, enabling a distinction between both positions. A capacitive sensor has a low energy consumption and is very reliable.

An electromagnetic sensor can be a piezoelectrical sensor configured to measure whether at least one temple is in an extended position. A skilled person knows how to employ the capabilities of a piezoelectrical sensor in order to measure an extended position of at least one temple. A piezoelectrical sensor is very exact and efficient.

An electromagnetic sensor can be an inductive sensor, in particular a linear variable differential transformer, an inductive displacement transducer, an inductive proximity sensor and/or an Eddy-current sensor. The inductive sensor is preferably configured to measure whether at least one temple is in an extended position. A skilled person knows how to employ the capabilities of an inductive sensor in order to measure an extended position of at least one temple. An inductive sensor allows an improved detection and a high flexibility with regard to the exact sensor type.

An electromagnetic sensor can be a magnetic sensor, in particular a Hall sensor. A Hall sensor or Hall effect sensor is preferably a device that is used to measure the magnitude of a magnetic field based on the Hall effect. Hall effect sensors can advantageously be used for proximity sensing, positioning sensing and/or speed detection. For example, a magnet can be attached to the chassis of the glasses in a region where the temple, whose position is to be detected is joined to the chassis, whereas the actual sensor is attached to the temple or vice versa. A respective movement and/or position of temple to chassis can then be distinguished by a change and/or difference in the magnetic field as detected by the sensor. A magnetic sensor is a very effective, uses established technology and is suited for mass production.

The sensor can be an optical sensor, for example, a light gate and/or a sensor for an electro-optical distance measurement. A sensor for an electro-optical distance measurement can in particular be a sensor for an optical runtime measurement and/or an interferometric measurement. The optical sensor is preferably configured to measure whether at least one temple is in an extended position. A skilled person knows how to employ the capabilities of an optical sensor in order to measure an extended position of at least one temple. An optical sensor is very robust and low maintenance.

The sensor can be an accelerometer. An accelerometer preferably measures the relative acceleration experienced by itself with respect to an inertial system or a system which can be approximated to be an inertial system, as for example the surface of the earth. An acceleration can comprise a linear and/or a rotational acceleration. An accelerometer can, for example, be electrical, piezoelectric, piezoresistive, based on magnetic induction and/or capacitive. It can in particular be a micro-electro-mechanical system (MEMS) or a strain gauge. By measurement, for example, of the acceleration of at least one temple with respect to the chassis, a position of the temple with respect to the chassis can preferably be derived. Preferably, two accelerometers could be employed, one comprised by the chassis and one comprised in at least one temple, allowing advantageously to derive the relative position (and/or a change in position) of the temple with respect to the chassis by a differential measurement between the two sensors. An accelerometer improves the detection. Also, accelerometers can advantageously be employed for additional applications/functions of the HMD.

A sensor can preferably perform a constant measurement. A constant measurement can comprise a continuous measurement data output by the sensor. A constant measurement can also comprise a time series of measurement data generated by the sensor, for example, at fixed temporal intervals.

A sensor can comprise a control unit, for example, an integrated circuit, in particular a microprocessor and/or a microprocessor unit (MCU) configured for performing the detection whether at least the first temple is in an extended position by an appropriate analysis of the data generated by the sensor.

The integrated circuit can preferably also be configured to implement further functions with regard to the HMD, it can, for example, be a control unit of the HMD

A sensor can preferably also be configured to detect, to perform a measurement and/or to supply measurement data only when a relevant change in position of at least the first temple with respect to the chassis takes place. The functioning of the switch can, for example, be interpreted in this way. Also, some simple capacitive sensor schemes can output an electric voltage only when there is a change in capacitance due to a change in position. These types of sensors advantageously have a very low power consumption and can advantageously also function when the HMD and/or all its components are in a power off mode.

It is preferred that the sensor and/or the integrated circuit can be supplied with electrical energy independently from the rest of the HMD. It can be particularly preferred that the sensor and/or the integrated circuit is supplied with electrical energy independently from the control of the power supply. This is, for example, useful when the detection can only be carried out when the sensor and/or the integrated circuit are supplied with electrical energy, for example, because a regular measurement is carried out by the sensor.

It can thus be preferred that the basic function comprises a control of power managment and/or a power supply which is not simply a connection/disconnection of the whole HMD to electrical energy. This preferably comprises a partial power on/off mode, where the electrical energy is connected/disconnected only to parts of the HMD. These parts can particularly comprise the visual data output, as for example a display and/or a projector for projecting data on (transparent) glasses of the HMD, and/or the functional unit.

It can on the contrary be preferred that the supply of the sensor and/or the integrated circuit of the HMD with electrical energy is not independent from the power mode of the rest of the device when the sensor comprises a(n) (electromechanical) switch (see above), since the “detection scheme” of the switch does essentially not require/consume electrical energy and therefore does not need an independent power supply.

It can be preferred that the basic function comprises a control of a power managment function. A power management function can in particular comprise the control of a low power consumption state or standby mode, respectively. Therefore, when a control of a basic function comprises a power management function, it comprises particularly a control whether the HMD is in a power on state or whether it is in a low power consumption state or standby mode, respectively.

Preferably, in addition to connect/disconnect a power supply and/or at least one battery, the temple/hinge on/off position also gives the possibility to control power on/off the system by using the temple/hinge information directly driving a power supply of the system or a partial part of the system (ON/OFF), or indirectly by the integrated circuit/MCU which uses the temple/hinge on/off information to control power supplies or set the system into sw power off or some other low power consumption state.

It can furthermore be preferred that while a basic function can comprise a connection/disconnection of the HMD or parts of it with the power supply, there can be at the same time a connection of the power supply to an external power supply, for example, for electrically charging the power supply of the HMD. This can in particular be controlled by the integrated circuit. When the basic function is controlled by the temple position during such a state, the system can nevertheless be powered on/off. The power can then come from the power supply of the HMD and/or the external power supply. But it can also be preferred in some cases that a control of a basic function is not possible during such a charging state of the power supply.

The basic function preferably comprises a connection/disconnection of the battery into the system (for example, the HMD) based on temple/hinge positions. There are cases that the integrated circuit or MCU can override this on/off switch by a separate control line and connect the battery into the system even when the temple(s)/hinges are in “OFF” position. This can be the case, for example, while charging the glasses, while they are in a case or not in a case. For example, when the glasses are in a case, the temple/hinge position is typically “OFF”. External power can be supplied by a charging interface and will wake the integrated circuit/MCU while the battery is yet disconnected from the system. Using this information, the integrated circuit/MCU can control an on/off switch in parallel to connecting the battery into the system and thus making the charging possible. When an external power is removed, the integrated circuit/MCU detects the temple/hinge position and lets the system go to power ON/OFF now only using the temple/hinge information.

In a further preferred embodiment of the invention the detection comprises a measurement of a relative angle, a relative threshold angle, a relative position, a relative threshold position and/or a relative movement of at least one temple.

A relative angle can, for example, be measured by an incremental encoder, for example, using at least one sensor as proposed herein. It can also be measured by other schemes employing sensors as described herein.

As a typical implementation, there can be a threshold angle concerning the relative angle between the temple and the chassis. The threshold angle could be some angle between the minimum angle, when the temple is in a folded position and the maximum angle, when the temple is in an extended position. This angle could, just as a reasonable example, be larger than 45°, for example, 50°, 60°, 70° or 80°. It could be an angle which is a little smaller than the maximum angle when the temple is extended, for example, 5° smaller or 10° smaller. The threshold angle then preferably marks a transition for the basic function to be controlled, for example, the basic function is switched when transitioning through the threshold angle from a smaller angle or a larger angle, respectively. For example, when the angle measured by the at least one sensor is bigger than the threshold angle, the power of the HMD is switched on, whereas when the angle is smaller than the threshold angle, the power of the HMD is switched off. Such a measurement could preferably also be realized by only measuring if a threshold angle is exceeded or fallen short of without a precise measurement of the angle itself.

Similarly, a threshold position of at least one temple can be measured as has been described previously.

It is clear to a person skilled in the art how the variables described above can be measured, for example, by using at least one sensor as presented within this document. It is also clear to a skilled person that all these variables can preferably be used in order to detect whether at least one temple is in an extended position.

A movement can preferably be measured by an inertial sensor unit and/or by an accelerometer.

A measurement of a relative angle, a relative threshold angle, a relative position, a relative threshold position and/or a relative movement of at least one temple advantageously allows for an improved detection whether at least one temple is in an extended position and for an improved method for a basic control of an HMD.

In a second aspect, the invention relates to an HMD, preferably for performing a method as described within this document. The device comprises a spectacle frame, which itself comprises a chassis and two foldable temples. Also, the HMD comprises at least one sensor. The spectacle frame is preferably configured for an at least temporary fixation of the HMD to a body (head) of a user. Preferably, a functional unit and/or a visual data output is also comprised and attached to the chassis. The sensor and the spectacle frame are configured for a detection whether at least one temple is in an extended position and for a control of a basic function of the head-mounted-display depending on the detection.

The skilled person acknowledges that advantages, definitions and embodiments of the inventive method also apply to the inventive device.

In a preferred embodiment of the invention the head-mounted display is selected from the group comprising data glasses, video glasses, first person view glasses, virtual reality headset, augmented reality glasses and/or smart glasses.

In a further preferred embodiment of the invention the sensor comprises a switch, an electromagnetic sensor, preferably a Hall sensor and/or a capacitive sensor, an optical sensor and/or an accelerometer, wherein the sensor is configured to measure a relative angle, a relative threshold angle, a relative position, a relative threshold position and/or a relative movement of at least one temple with respect to the chassis.

In a further preferred embodiment of the invention the device comprises a power supply, preferably a battery, wherein power supply and sensor are configured for a control of the power supply (a supply of electrical power) to the HMD.

### BRIEF DESCRIPTION OF THE DRAWINGS

The invention will now be described with reference to the drawings wherein:

FIG. 1 shows exemplary data glasses in a power off-mode.

FIG. 2 shows exemplary data glasses in a power on-mode.

FIG. 3 is a schematic of a circuit configuration wherein a sensor unit is connected to a power supply.

FIG. 4 shows an exemplary embodiment of the method according to the disclosure.

### DESCRIPTION OF THE PREFERRED EMBODIMENTS

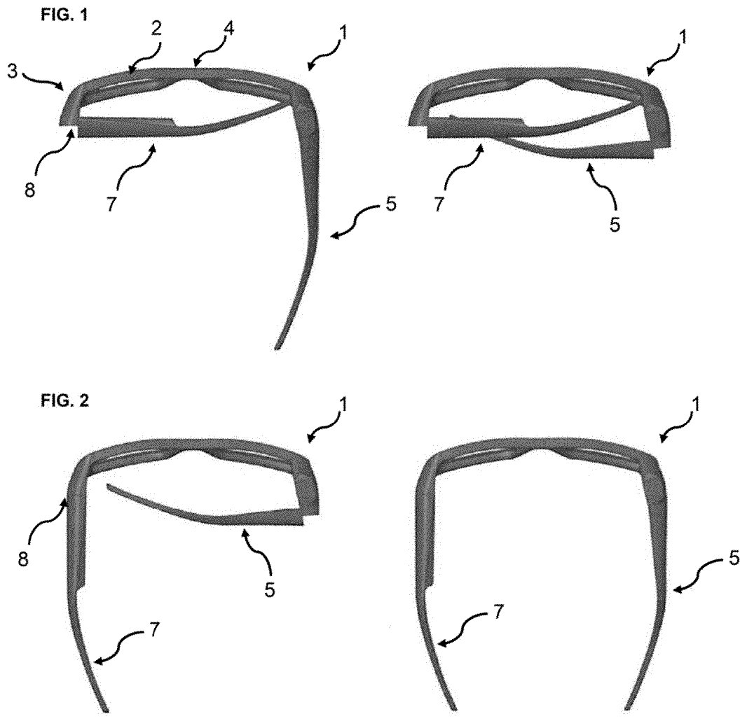

FIG. 1 and FIG. 2 show an HMD 1 in the form of data glasses 1 seen from above. The data glasses 1 comprise a spectacle frame 3 with a chassis 4, to which transparent eyeglass lenses are attached in this embodiment. The eyeglass lenses serve at the same time as visual data output 2. The spectacle frame furthermore comprises foldable temples, one to the left 7 and one to the right 5. In the embodiment shown, the detection of an extended position of at least one temple is realized by the detection of an extended state of exactly one temple, the first temple, of the spectacle frame 3. Here, it is the left temple 7. Only the extended state of the left temple 7 results in the control of the basic function of the data glasses 1. Here, the basic function is a power on mode. Thus, in this embodiment, only the left temple 7 in an extended position results in a power on mode. The position of the left temple 7 (extended or folded) can be detected by a sensor at location 8 (here, the sensor unit itself is not explicitly shown, only a typical position thereof) which is positioned in a region where the left temple 7 is hinged to the chassis 4.

Thus, FIG. 1 shows the data glasses 1 in a power off mode. There are two realization of temple positions of the shown embodiment in power off mode, one to the left on FIG. 1 and one to the right. As shown on the left side of FIG. 1, the left temple 7 is in a folded state or position and the right temple 5 is in an extended state or position. On the right side of FIG. 1, both left 7 and right temples 5 are in a folded position. The power is shut down since in both cases the left temple 7 is folded, irrelevant of the position of the right temple 5.

FIG. 2 shows the data glasses 1 in power on mode. Both realizations, on the left side and on the right side of FIG. 2, show an extended left temple 7. While on the left side of FIG. 2, the right temple 5 is in a folded position, on the right side of FIG. 2 both left 7 and right temple 5 are in an extended position and the data glasses 1 are ready to be worn by the user. It can thus be seen that while only the detection of the state of the left temple 7 is decisive for the control of the power mode, it can still be ensured that that power is always on when the data glasses 1 are ready to be worn, with both left 7 and right temple 5 extended. Like this, extra components for the detection of the position of the right temple 5 can be saved while keeping the desired functionality of a basic control mechanism which is useful, intuitive and resource friendly.

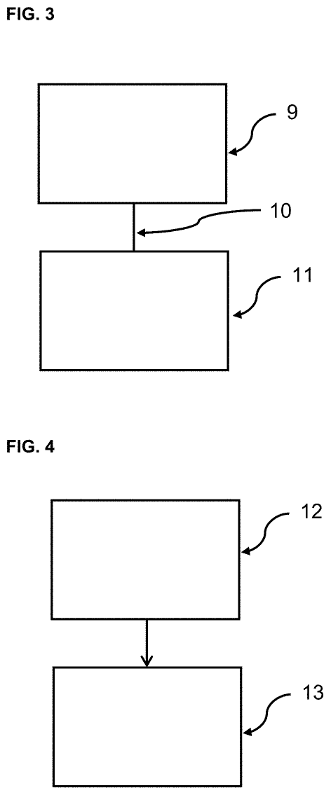

FIG. 3 shows schematically an embodiment of a circuit configuration for the head-mounted display of the disclosure. A sensor unit 9 is connected electrically 10 to a power supply such that the power supply 11 can be controlled by the sensor unit 9. When the sensor unit 9 detects at least one foldable temple in an extended position, the power supply 11 can, for example, be switched on via the electrical connection 10.

FIG. 4 shows an exemplary method schematically. In step 12, the sensor unit 9 detects whether at least one temple is in an extended position. Then, in step 13, a basic function can be controlled as a function of that detection.

It is understood that the foregoing description is that of the preferred embodiments of the invention and that various changes and modifications may be made thereto without departing from the spirit and scope of the invention as defined in the appended claims.

### REFERENCE SIGNS

1 HMD, for example, data glasses
2 Visual data output
3 Spectacle frame
4 Chassis of the spectacle frame
5 Second temple, for example, right temple
7 First temple, for example, left temple
8 Sensor location
9 Sensor unit
10 Electrical connection
11 Power supply
12 Step of detecting whether at least one foldable temple is in an extended position
13 Step of controlling basic function

What is claimed is:

1. A method for controlling a basic function of a head-mounted display having a spectacle frame defined by a chassis and first and second foldable temples, the method comprising the steps of:
detecting via at least one sensor unit whether at least one of the first and second foldable temples is in an extended position; and,
controlling the basic function of the head-mounted display in dependence upon whether the at least one of the first and second foldable temples is in an extended position.

2. The method of claim 1, wherein the step of detecting comprises detecting whether the at least one of the first foldable temple and the second foldable temple is in an extended position.

3. The method of claim 1, wherein the step of detecting comprises detecting whether at least the first foldable temple is in an extended position.

4. The method of claim 1, wherein the step of detecting comprises detecting only whether the first foldable temple is in an extended position.

5. The method of claim 3, wherein the step of detecting comprises detecting whether both the first foldable temple and second foldable temple are in the extended position.

6. The method of claim 1, wherein the basic function comprises controlling the power supply of the head-mounted display; and, the step of detecting that at least one of the temples of the first and second foldable temples is in the extended position causes a power-on mode of the head-mounted display.

7. The method of claim 1, wherein the sensor unit includes a switch, and at least one of an electromagnetic sensor, a capacitive sensor, an optical sensor and an accelerometer; and,
the step of detecting comprises making a measurement of at least one of the following: a relative angle, a relative threshold angle, a relative position, a relative threshold position and a relative movement of at least one of said first and second foldable temples with respect to the chassis.

8. A head-mounted display comprising:
a spectacle frame defining a chassis and first and second foldable temples;
at least one sensor unit;
said sensor unit and said spectacle frame being configured to detect whether at least one of said foldable temples is in an extended position and to control a basic function of said head-mounted display.

9. The head-mounted display of claim 8, wherein said head-mounted display is selected from the group comprising at least one of the following: data glasses, video glasses, first person viewing glasses, virtual reality headset, augmented reality glasses and smart glasses.

10. The head-mounted display of claim 8, wherein:
said sensor unit includes at least one of the following: a switch, an electromagnetic sensor, a capacitive sensor, an optical sensor and an accelerometer; and,
said sensor unit is configured to measure at least one of the following: a relative angle, a relative threshold angle, a relative position, a relative threshold position and a relative movement of at least one of said first and second foldable temples with respect to said chassis.

11. The head-mounted display of claim 10, wherein said electromagnetic sensor is a Hall sensor.

12. The head-mounted display of claim 8, further comprising a power supply; and, said sensor unit and said power supply being configured to control a supply of power to said head-mounted display.

13. The head-mounted display of claim 12, wherein said power supply is a battery.
